(19) United States
(12) Patent Application Publication
(10) Pub. No.: US 2004/0122773 A1
(43) Pub. Date: Jun. 24, 2004

(54) Digital jukebox system and method

(76) Inventors: George C. McCombs, Jacksonville, FL (US); Fabian Acevedo, Orange Park, FL (US)

Correspondence Address: Mark J. Young, McGuireWoods LLP, 50 North Laura Street - Suite 3300, Jacksonville, FL, 32202, US

(21) Appl. No.: 10/328,465

(22) Filed: Dec. 23, 2002

(51) Int. Cl. G06F 17/60

(52) U.S. Cl. 705/52

(57) ABSTRACT

A digital jukebox system provides means for copying digital music data, means for encoding the copied digital music data into compressed high-quality digital music files, means for archiving the encoded digital music files, means for monitoring the frequency an archived file is played, and means for maintaining a list of a determined number of most frequently played files. The system may be implemented in a conventional CD or record jukebox shell.

### FIELD OF THE INVENTION

This invention relates generally to jukeboxes and more particularly to a digital jukebox system that may be implemented in a conventional jukebox without access to a computer network.

### BACKGROUND

Conventional compact disc jukeboxes suffer several limitations. First, they typically store a limited number (e.g., 100) of compact discs. This limits the total number of user selections. Second, the complex electrical and mechanical components required for storing and changing compact discs require frequent repair. Likewise, costly lasers for playing compact discs require frequent replacement, especially when contaminated by residue from tobacco smoke.

In recent years, digital jukeboxes have emerged. These jukeboxes typically require a network connection and subscription service to download digital music files for playback. As a dial-up network connection might not provide adequate bandwidth to efficiently deliver digital music files, costly broadband network connectivity (e.g., a DSL, cable, ISDN or T1 connection) may be required. Additionally, problems with the network connection and transmitted viruses or other harmful code can incapacitate the jukebox. Furthermore, as the infrastructure and licensing fees required to implement such a service are costly, the cost per song tends to be relatively high. Moreover, as the mainstream recording industry has not yet fully embraced downloaded digital music files (such as MP3) due to piracy concerns, legitimate recordings from many popular recording artists may be unavailable.

Thus, a digital jukebox system that may be implemented in a conventional jukebox shell and does not require access to a computer network, is needed. The system preferably eliminates costly lasers and complex electrical and mechanical components required for storing and changing compact discs in conventional jukeboxes. The system is also preferably easy to service and use.

### SUMMARY

It is therefore an object of the present invention to provide a digital jukebox system that may be implemented in a conventional jukebox shell and does not require access to a computer network.

It is another object of the present invention to provide a digital jukebox system that enables the creation and archiving of compressed digital music files from conventional compact disks.

It is also another object of the invention to provide a digital jukebox system that maintains a list of favorite selections.

To achieve these and other objects, a system in accordance with an exemplary embodiment of the present invention includes means for copying digital music data, means for encoding the copied digital music data into compressed high quality digital music files, means for archiving the encoded digital music files, means for monitoring the frequency an archived file is played, means for maintaining a list of a determined number of most frequently played files.

### BRIEF DESCRIPTION OF THE DRAWINGS

The foregoing and other objects, features and advantages of the present invention will become better understood with reference to the following description, appended claims, and accompanying drawings, where:

FIG. 1 is a block diagram that conceptually depicts components of a digital jukebox system in accordance with an exemplary implementation of the present invention;

FIG. 2 is a high-level flowchart that conceptually depicts exemplary administrative functions in accordance with a preferred implementation of the present invention;

FIG. 3 is a high-level flowchart that conceptually depicts an exemplary archiving process in accordance with a preferred implementation of the present invention;

FIG. 4 is a high-level flowchart that conceptually depicts an exemplary play level setting process in accordance with a preferred implementation of the present invention; and

FIG. 5 is a high-level flowchart that conceptually depicts exemplary lock and unlock processes in accordance with an implementation of the present invention; and

FIG. 6 is a high-level flowchart that conceptually depicts an exemplary metering process in accordance with an implementation of the present invention; and

FIG. 7 is a high-level flowchart that conceptually depicts a song play process in accordance with an implementation of the present invention; and

FIG. 8 is a high-level flowchart that conceptually depicts a song selection process in accordance with an exemplary implementation of the present invention; and

FIG. 9 is a diagram that conceptually depicts an administrative “service mode” graphical user interface (gui) screen in accordance with an exemplary implementation of the present invention; and

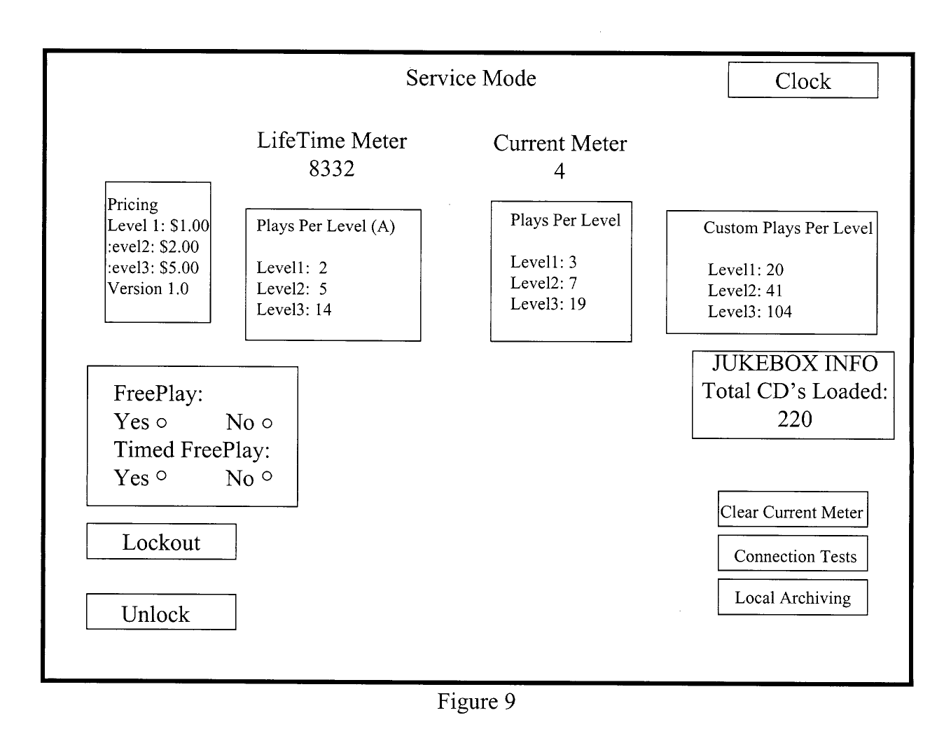

FIG. 10 is a diagram that conceptually depicts a main selection screen in accordance with an exemplary implementation of the present invention; and

FIG. 11 is a diagram that conceptually depicts a top ten selection screen in accordance with an exemplary implementation of the present invention; and

FIG. 12 is a diagram that conceptually depicts an artist selection screen in accordance with an exemplary implementation of the present invention; and

FIG. 13 is a diagram that conceptually depicts a title selection screen in accordance with an exemplary implementation of the present invention.

### DETAILED DESCRIPTION

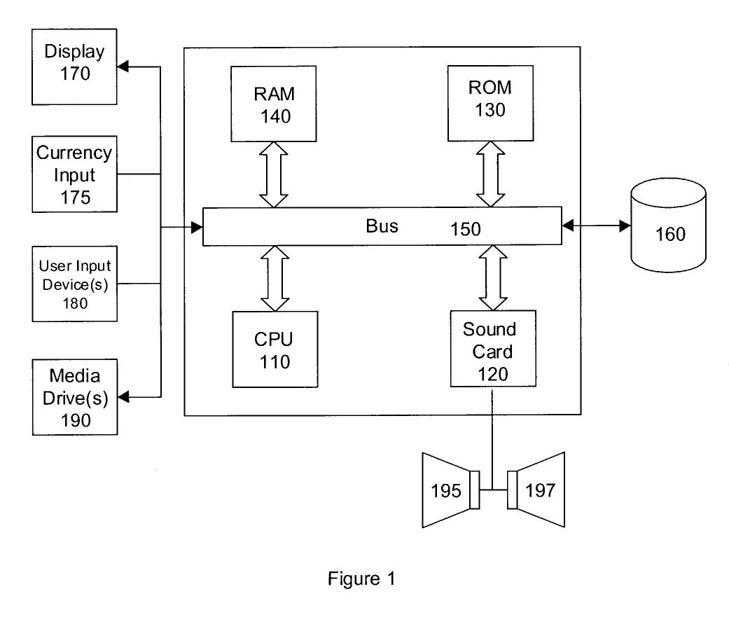

Referring to FIG. 1, a digital jukebox system in accordance with an exemplary embodiment of the present invention preferably includes a computer system having a bus 150 for communicating information, a central processing unit (CPU) 110, a read only memory (ROM) 130, a random access memory (RAM) 140, a mass storage device 160, one or more removable media drives 190, a display device 170, a sound card 120, an input device 180 and a payment device 175. The mass storage device preferably is a hard disk, though other mass storage means such as memory, tape drives and/or other storage equipment may be used without departing from the scope of the present invention. The removable media drives preferably include an internal or external CD-ROM drive capable of reading data from music compact discs (CDs) and an internal or external diskette drive. Other drives in addition to or in lieu of either or both of the aforementioned drives may be included to enable use of the system with other removable media without departing from the scope of the present invention. The input device may be a keyboard, a touch sensitive screen, a pointing device or the like, as well as combinations thereof. The sound card produces analog signals for speakers from digital music files. Speakers may be internal or external to the system. The payment device may be a conventional vending device for accepting coins and bills for payment and/or a magnetic card reader for processing credit or debit card payments. The display device may be a CRT monitor or LCD display.

These elements (except the payment device) are typically included in most computer systems and the aforementioned system is intended to represent a broad category of computer systems capable of storing and processing digital music files and related data in accordance with the present invention. Of course, the system may include fewer, different and/or additional elements, provided the system is capable, when programmed, of performing functions in accordance with the present invention. The system may take various different forms. Those of skill in the art will understand that the present invention may be implemented using systems comprised of digital signal processors (DSP), application-specific integrated circuits (ASIC), discrete gate logic, or other hardware, firmware, or any conventional programmable software module and a microprocessor. Software modules used to implement the present invention could reside in ROM, RAM, flash memory, registers, or any other form of readable and writable storage medium known in the art.

A system in accordance with an exemplary embodiment of the present invention generally provides means for system administration (or service) and means for end-user utilization. Preferably, a switch or other mode selection means that is readily accessible only to a user with administrative privileges enables switching between administrative (or service) modes and end-user (or play) modes. For example, a switch within a locked jukebox cabinet or a special key combination activating a password protected login screen may be provided to enable system administration.

In an exemplary implementation, a graphical user interface (gui) facilitates navigation through various screens. By selecting icons in an intuitive manner, a user may cause the system to perform determined functions.

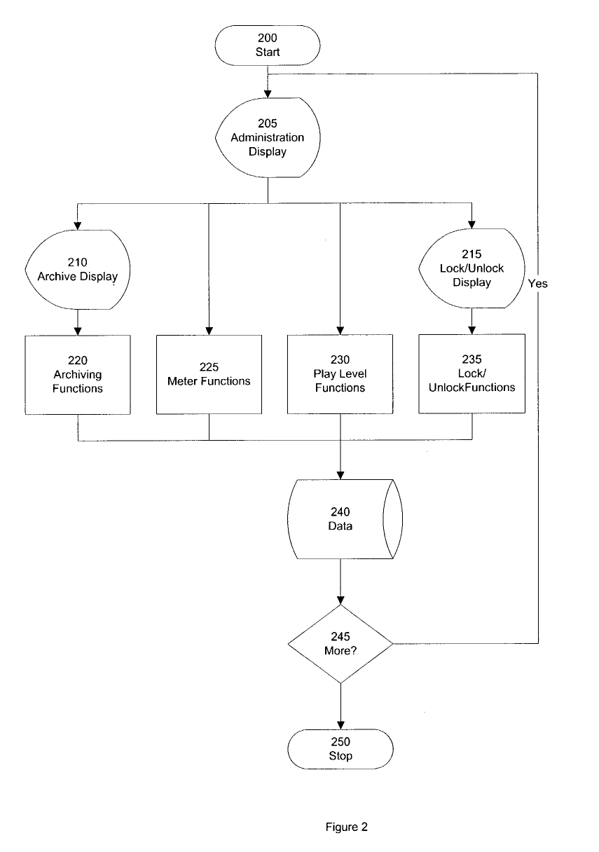

Referring now to FIG. 2, a high-level flowchart of administrative (or service) processes is shown. A gui-enabled main administration screen display 205 allows a user to select an available administrative function. The selection may be linked (e.g., hyperlinked) to another screen or activate the function. Administrative functions may include archiving 220, metering 225, play level 230 and lock functions 235. These functions may include steps of sending and receiving data to the system's mass storage device 240. The data may be stored in tables, databases or other files.

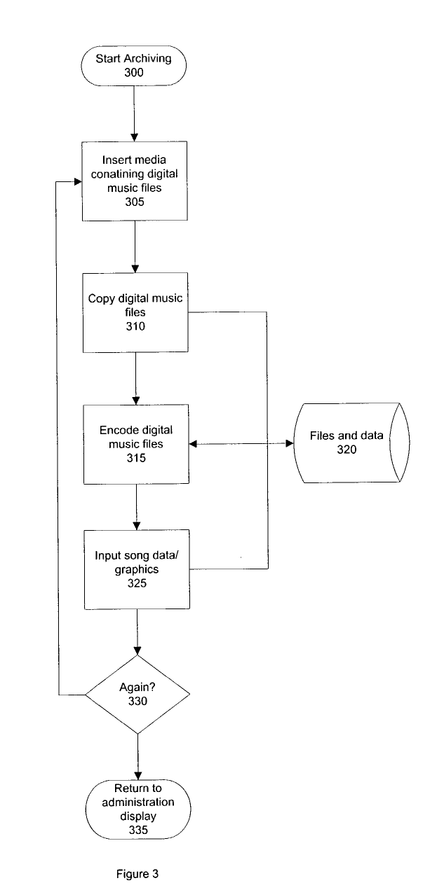

The archiving functions preferably include means for producing and to storing on the system's mass storage device compressed music files based on music compact discs (CDs). Referring now to FIG. 3, an exemplary archiving process (and means) entails copying digital music files from an audio CD through a process called “ripping,” as is well known in the art 305-310, 320. Ripping entails copying digital data corresponding to audio on a CD. The copied data is then preferably encoded 315, using an encoding process. In general, encoding entails converting the data into a desired format. A common format for computer readable sound file is MP3 (MPEG-1 Audio Layer-3). MP3 files, which are preferred, are typically created by encoding a sound sequence into a smaller file (about one-tenth to one-fourteenth the size of the raw CD data). While MP3 files are “lossy,” meaning that the encoding process omits some digital information, the omitted information tends to correspond to sounds that most people cannot hear well or distinguish well from other sounds. If a high sampling rate (e.g., 128 kbps) is used to generate MP3 files, the sound quality is nearly equivalent to that of the original CD audio for most practical purposes, but occupies approximately one-tenth or less of the storage space.

After encoded music files are stored in the system, data and graphics may be input and associated with the files 325 and 320. For example, a title may be associated with each file. Album cover artwork may be associated with each group of files from a music CD.

An important advantage of the present invention is the ability to store a significant quantity of music files using commercially available computer hard disks. A typical CD can store approximately 74 minutes of music, corresponding to approximately 783,216,000 bytes of data. Assuming an average music CD has approximately 10 songs, then 20 gigabytes of conventional hard disk storage space would allow storage of roughly the equivalent of 25 compact discs, or 250 music files, or 30 hours of CD music. Advantageously, the present invention enables storage of 2,500 or more MP3 music files corresponding to 300 hours or more of near-CD quality music using the same hard disk storage space.

Another advantage of the present invention is that it facilitates the archiving of music files from music CDs. Users are limited to limited titles available through a subscription service. Instead, songs from any CDs may be loaded onto the system.

Jukebox operators should obtain appropriate licenses to perform the songs in a public setting, if necessary. While such licenses may be obtained from artists and their representatives, well known music licensing organizations (such as American Society of Composers, Authors and Publishers [ASCAP], Broadcast Music, Inc. [BMI], SESAC, Inc. [SESAC] and the Jukebox License Office [JLO]) offer appropriate licenses. As a jukebox system in accordance with the present invention avoids downloading and streaming of digital music files, it may qualify for the standard Jukebox License Agreement by JLO.

An operator of a jukebox in accordance with the present invention should also preferably retain each CD purchased in connection with the system. Additionally, a CD should preferably be used for only one jukebox and to create one encoded version of the songs from that CD. Thus, each digital music file on a specific digital jukebox will correspond to a CD used to create that file. The corresponding CD will preferably not be used to play songs and will not be used to create digital music files for any other digital jukebox. In a preferred implementation, the CDs may be stored in space available within the jukebox cabinet itself.

To guard against unauthorized removal and copying of software stored on the mass storage device of the system, a hardware security device such as a “dongle” may be utilized. Such a device enables encryption of software. The device includes a key to enable decryption of encrypted software. Typically, such devices may be connected via a port, such as a parallel, serial or USB port as found in most conventional computer systems. Thus, a hard drive removed from a system in accordance with the present invention will preferably contain encrypted software protected from use without the dongle.

In another embodiment, a dongle or similar security device may be used to protect encoded music files stored on the mass storage device of the system. Such a device may enable encryption of the files. The key provided in the dongle would enable decryption. Thus, the encrypted encoded files would be protected from use without the dongle.

An intuitive user interface preferably activates the ripping and encoding processes required to create MP3 files. For example, an administrative user may place a music CD in a CD player attached to the system. Next, the administrative user may select an icon or enter a command to commence the archiving (i.e., ripping and encoding) process for selected songs or all songs on the CD. Each encoded song may be stored on the system as a separate file. All files from a CD or a particular artist may be stored in a specific folder or directory. Data pertaining to a song file, such as a title, artist and related graphics file can be stored in a database, table or files. Such data may be entered manually by an administrative user, copied from a diskette or other removable media or otherwise input into the system.

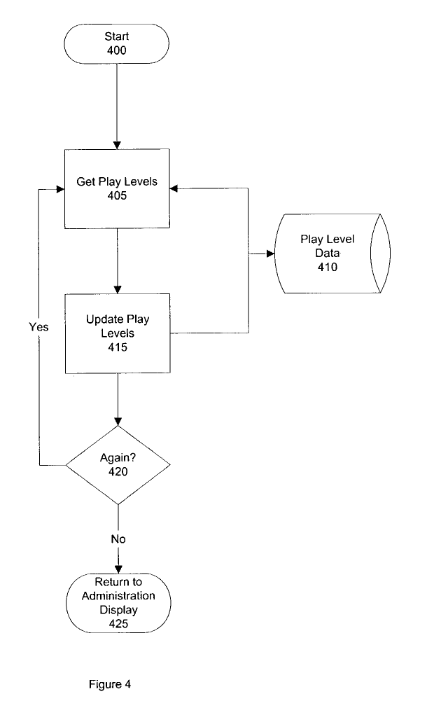

Referring now to FIG. 4, an exemplary process and means for setting play levels in accordance with the present invention is conceptually shown. The process is preferably accessible via the main administrative screen. Plays per level refer to the number of plays at a pricing level. There may be several categories of plays per level, such as a category A, category B, category C and so on. An operator may select an appropriate category and set the plays per level in that category. For example, pricing for level 1 may be $1.00, pricing for level 2 may be $2.00 and pricing for level 3 may be $5.00. In category A, plays per level for level 1 may be 2, for level 2 may be 5 and level 3 may be 14, thus providing volume incentives. In category B, plays per level for level 1 may be 3, for level 2 may be 7 and level 3 may be 19, again providing volume incentives. Pricing per level values and play per level values may be entered and/or updated by an operator using a conventional input means.

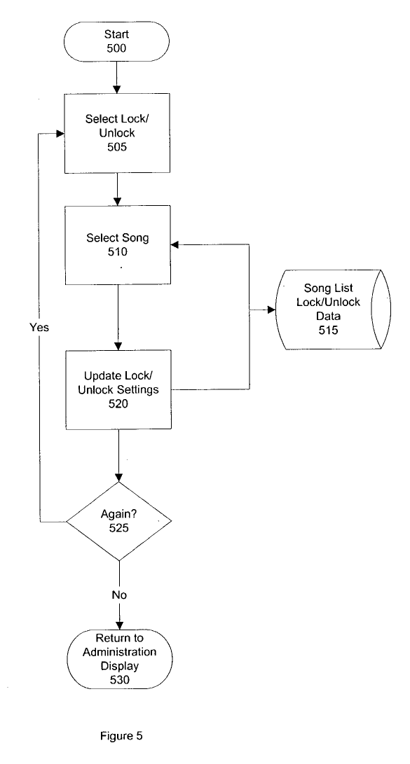

Referring now to FIG. 5, a process and means for locking songs is conceptually shown. The process is preferably accessible via the main administrative screen. When “locked”, a song cannot be selected or played on the system. Songs that are considered too long or contain vulgar or profane lyrics are typical candidates for locking. When “unlocked”, which is preferably the default setting for a song, the song can be selected and played. The process for locking generally entails selecting a song (e.g., from an alphabetical list of titles) and selecting a lock or unlock setting as the case may be 505, 510. The selected setting is then stored for the selected song 515.

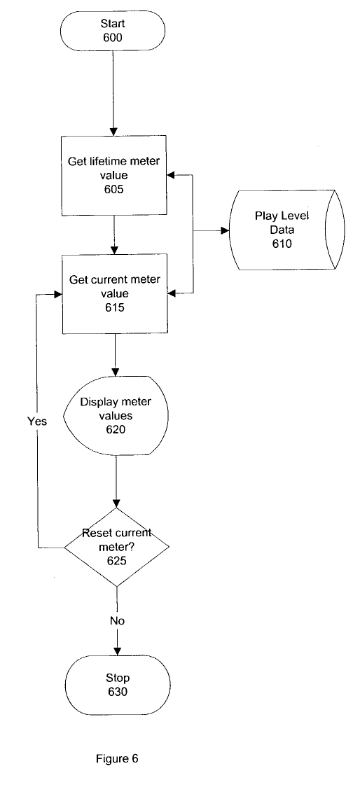

FIG. 6, conceptually illustrates an exemplary process and means for updating meter values in accordance with the present invention. The process is preferably accessible via the main administrative screen. A lifetime meter provides a count of the total number of plays for a system.

It is useful for maintenance purposes and accounting purposes. Each time a song is played the lifetime meter is incremented by one. The current meter provides a count of the total number of plays for a system from the last reset of the current meter. The current meter may be reset to zero, for example by selecting a “reset current meter” icon 625. Thus the current meter may be used to count the total number of plays between two events (e.g., two service visits). The lifetime meter value and the current meter value may be displayed, for example on the main administrative screen 620.

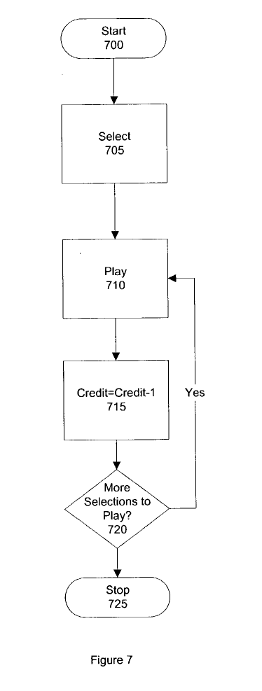

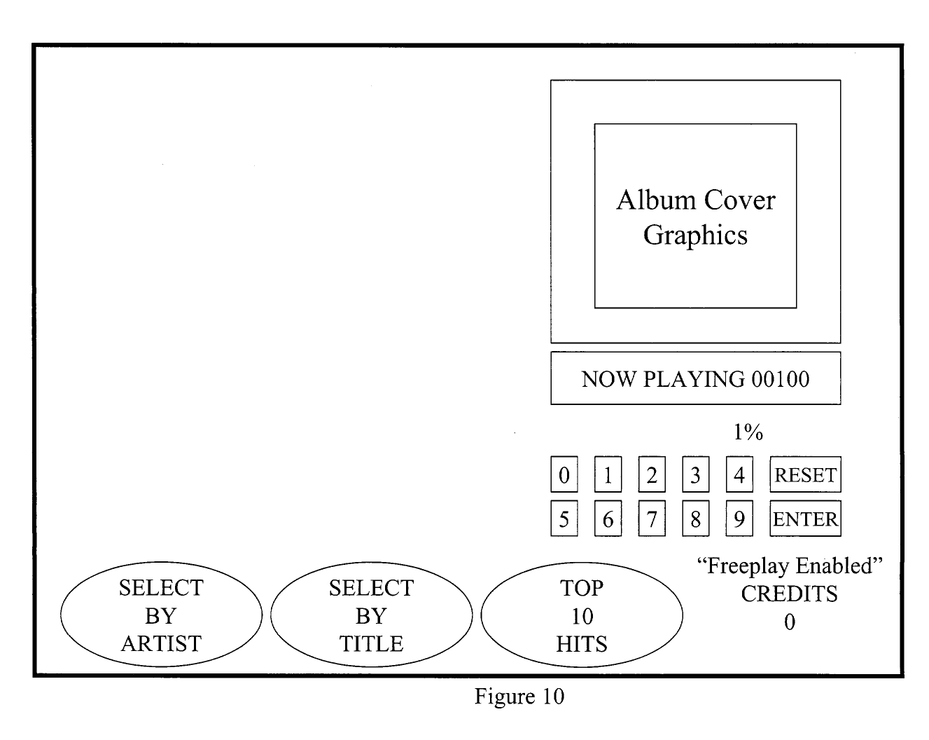

FIG. 7 is a high-level flowchart that conceptually illustrates an exemplary song play process in accordance with the present invention. The process is preferably accessible via a main selection screen, such as the screen conceptually depicted in FIG. 10. The process generally entails selecting a song by artist, title or from a list of favorites. Selected songs are queued and played in order 710. After each play, the credit (i.e., the number of plays purchased) is reduced by one, so long as the jukebox is not in “free play” mode 715. In free play mode, credits are not required. The play process repeats until all queued songs have been played 720.

In an exemplary embodiment, plays may be purchased by depositing money in the payment device. Upon an adequate deposit, the payment device provides a signal representative of the amount paid. Credits are awarded according to an applicable play per pay level.

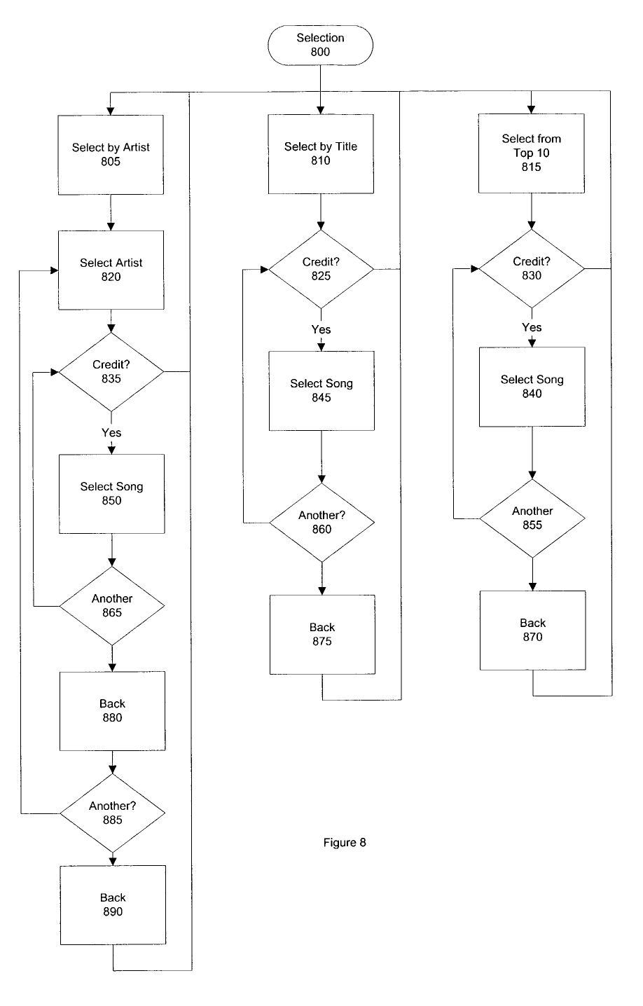

FIG. 8 is a high-level flowchart that conceptually illustrates an exemplary selection process in accordance with the present invention. The process is preferably accessible via a main selection screen, such as the screen conceptually depicted in FIG. 10. The process generally entails selecting a song by artist, title or from a list of favorites.

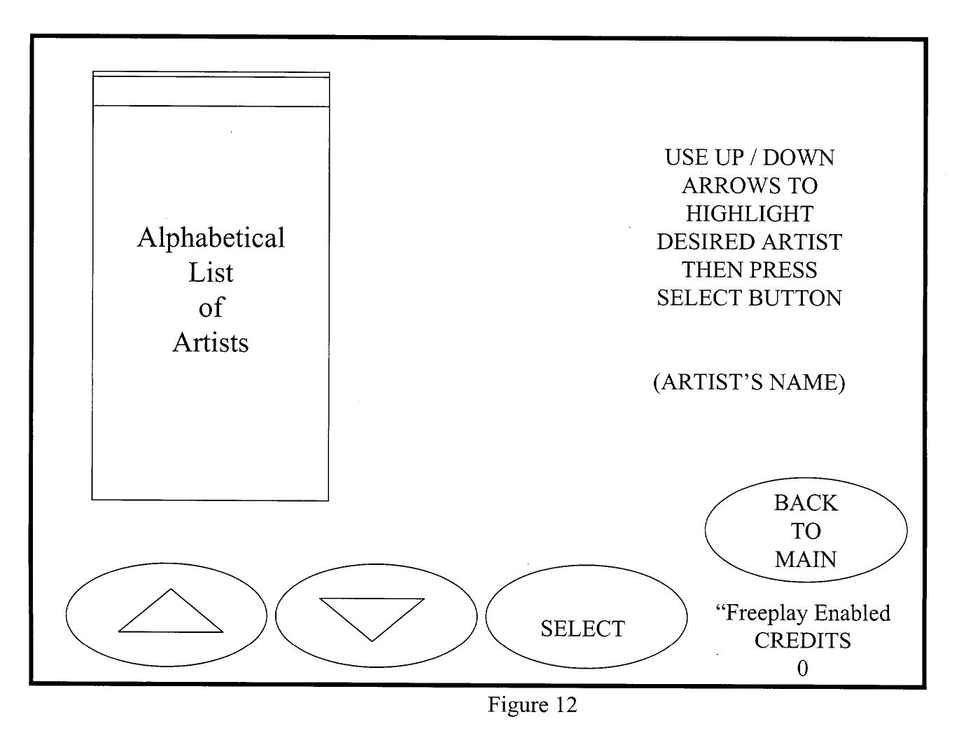

An exemplary selection by artist process 805 entails selecting an artist from a list (e.g., an alphabetical list) of artists, such as via a screen with a scrolling means as conceptually depicted in FIG. 12. Then a song is selected from a list (e.g., an alphabetical list) of available songs for the artist 850. Locked songs are either not shown or not selectable. The song selection process may repeat for selecting additional songs by the selected artist 865. The artist selection process may also be repeated to select a another artist 885.

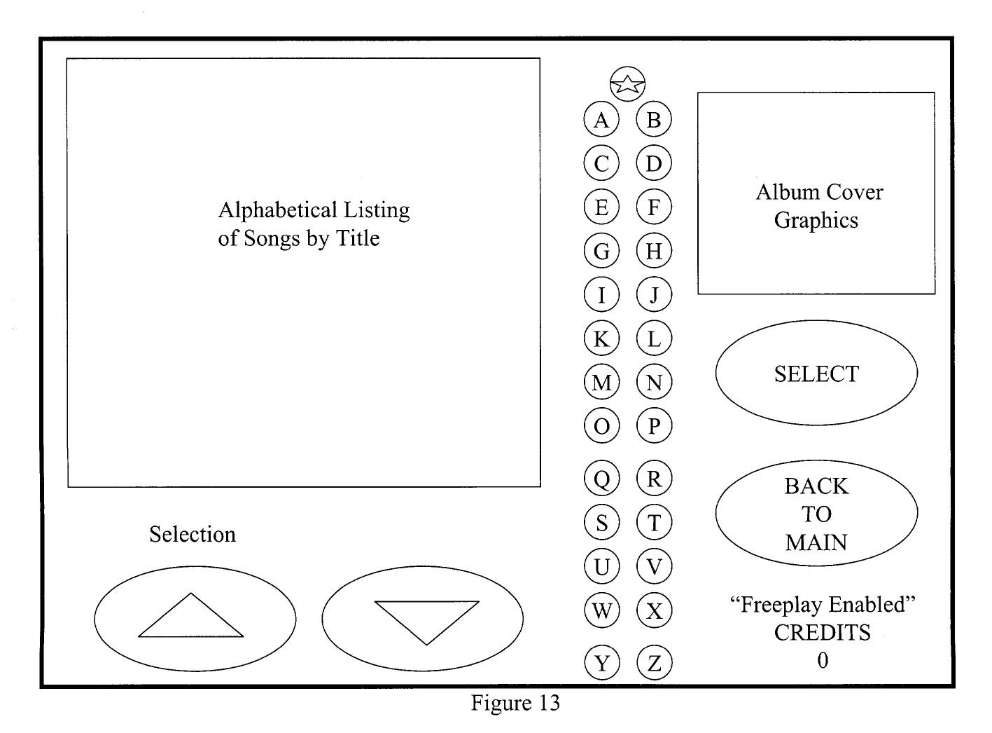

An exemplary selection by title process 810 entails selecting a song by title from a list (e.g., an alphabetical list) of available songs 845, such as via a screen with a scrolling means as conceptually depicted in FIG. 13. The title selection process may be repeated to select another title 860.

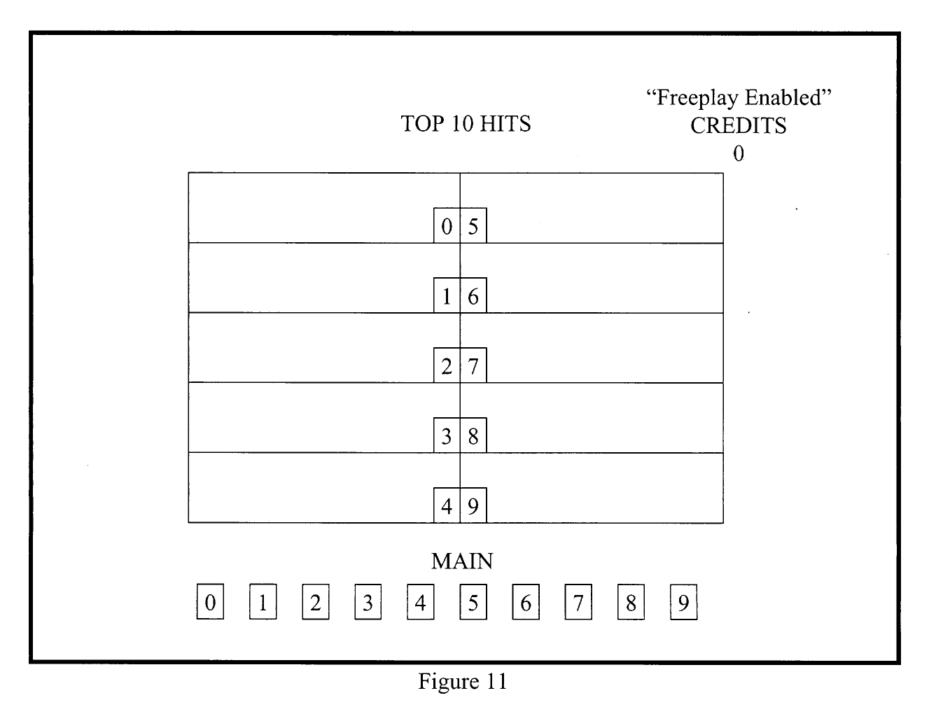

An exemplary process for selecting a song from a list of favorites, such as a top ten list 815, entails selecting a title from a list of most frequently selected titles, such as via a screen with a selection means as conceptually depicted in FIG. 11. An advantage of the present invention is the ability to automatically update a list of favorite selections. A system in accordance with a preferred implementation of the present invention preferably tracks the number of times each song is played (i.e., a selection number). A determined number of most frequently played songs (e.g., the top ten songs corresponding to the ten highest selection numbers) comprise a list of favorites. The favorite selection process may be repeated to select another title from the list of favorites 855. Thus the list reflects the favorite songs for the particular system.

Those skilled in the art will appreciate that the various data sources conceptually illustrated in the flowcharts may be combined into one or a plurality of data sources. They are shown and numbered as separate units to keep the flowcharts simple and easy to follow. Additionally, the data may be stored and managed using a database management system known in the art.

While the invention has been described in terms of its preferred embodiments, those skilled in the art will recognize that the invention can be practiced with modifications within the spirit and scope of the foregoing detailed description. Such alternative embodiments and implementations are intended to come within the scope of the present invention.

Having thus described the invention, what I claim as new and desire to secure by Letters Patent is as follows:

1. A digital jukebox system comprised of means for copying digital music data from a removable medium, means for encoding the copied digital music data into a compressed digital music file, means for archiving the encoded digital music files, means for receiving a payment, said digital jukebox system not having a computer network connection.

2. A digital jukebox system as in claim 1, said system being further comprised of a touch-sensitive display screen.

3. A digital jukebox system as in claim 2, said system being further comprised of a graphical user interface to facilitate use.

4. A digital jukebox system as in claim 1, said system being further comprised of means for monitoring the frequency an archived file is played and means for maintaining a list of a determined number of most frequently played files.

5. A digital jukebox system as in claim 1, wherein said means for copying digital music data from a removable medium is a compact disc drive and said removable medium is a compact disc storing digital music data.

6. A digital jukebox system as in claim 1, said system being further comprised of a database management system for managing information related to encoded digital music files.

7. A digital jukebox system as in claim 6, wherein said information related to encoded digital music files includes an artist name, a CD title, a selection number, a graphic image, a song title and a locked/unlocked indicator.

8. A digital jukebox system as in claim 1, wherein said means for encoding digital music files and said means for archiving the encoded digital music files are comprised of encrypted software, and said system is further comprised of a hardware security device having a key used for decryption.

9. A digital jukebox system as in claim 1, said system being further comprised of a means for setting play levels.

10. A digital jukebox system as in claim 1, said system being further comprised of a means for locking and unlocking said digital music files.

11. A digital jukebox system as in claim 1, said system being further comprised of a means for selecting a digital music file by artist, title or from a list of favorites.

12. A digital jukebox system comprised of a compact disc drive, means for encoding the copied digital music data into a compressed digital music file, means for archiving the encoded digital music files, a touch-sensitive display screen, a graphical user interface to facilitate use, means for monitoring the frequency an archived file is played and means for maintaining a list of a determined number of most frequently played files, means for setting play levels, means for locking and unlocking said digital music files, a database management system for managing information related to the encoded digital music files, said information related to encoded digital music files including an artist name, a CD title, a selection number, a graphic image, a song title and a locked/unlocked indicator, means for selecting a digital music file by artist, title or from a list of favorites, said digital jukebox system not having a computer network connection.

13. A digital jukebox system as in claim 12, wherein said means for encoding digital music files and said means for archiving the encoded digital music files are comprised of encrypted software, and said system is further comprised of a hardware security device having a key used for decryption.

14. A digital jukebox method comprised of copying digital music data from a removable medium, encoding the copied digital music data into a compressed digital music file, archiving the encoded digital music files, receiving a payment, receiving a digital music file selection and playing the selected digital music file.
